(19) United States
(12) Patent Application Publication
(10) Pub. No.: US 2025/0240198 A1
(43) Pub. Date: Jul. 24, 2025

(54) Controller Group, Transportation Means, and Method for Communication Between Control Devices of a Transportation Means

(71) Applicant: Bayerische Motoren Werke Aktiengesellschaft, Muenchen (DE)

(72) Inventors: Fabian HEHL, Muenchen (DE); Thomas KLAWITTER, Muenchen (DE)

(21) Appl. No.: 18/703,395

(22) PCT Filed: Oct. 5, 2022
(86) PCT No.: PCT/EP2022/077709

§ 371 Date: Apr. 22, 2024

(30) Foreign Application Priority Data
Nov. 3, 2021 (DE) 10 2021 128 534.8

(51) Int. Cl. H04L 41/0604; H04L 41/0659; H04L 67/12

(52) U.S. Cl. CPC H04L 41/0627; H04L 41/0661; H04L 67/12

(57) ABSTRACT

Methods, systems, and apparatuses are provided for communication between electronic control devices for a transportation vehicle. A request is sent by a first electronic control device to a second electronic control device. The second electronic control device is determined to not react to the request in response. A data set assigned to the second electronic control device is automatically adapted. The data set is automatically written on an instance located outside the second electronic control device. The data set is applied in the instance to initiate a reaction of the second electronic control device to the request.

### BACKGROUND AND SUMMARY

The present subject matter relates to a controller group, a transportation means, and a method for communication between control devices of a transportation means. In particular, the present subject matter relates to remedying communication problems between control devices within a transportation means.

The theme of “energy efficiency” will play a more and more important role in the future in the development of transportation means. Many different control devices for greatly varying functions are already installed at present in a transportation means, which are often supplied jointly with electrical energy and are jointly guided in an active communication status. This circumstance results in increased energy consumption, which in turn causes reduced ranges, greater starter battery capacities, and thus costs. Terminal definitions for the electrification of the vehicle electrical system were defined many years ago in the prior art, for example, in DIN 72552. The bus-controlled or network-controlled power supply of individual vehicle components (in particular control devices) enables expanded switching on or off of electrical consumers in the transportation means by the use of so-called “eFuses” or “relays”, which can decouple electrical components located after them from the energy supply and/or from communication channels.

The large number of control devices and activatable switches causes a certain lack of clarity of the vehicle electrical system architecture. As a result, communication problems are often identified in the vehicle development which are to be attributed to incorrectly activated switches and control devices.

Those responsible for functions and component developers are not always the same person, from which a certain lack of knowledge on the part of the respective control device developer is caused by which functions are located on their control devices. Moreover, progressive implementations and modifications of locations of individual functions on various control devices in the vehicle in the course of the development process of vehicles makes the troubleshooting more difficult.

It is an object of the present subject matter to alleviate or solve the problems of the prior art.

The above-mentioned object is achieved according to the present subject matter by a method for communication between control devices for a transportation means. The control devices are also designated as “electronic control units” (ECUs). The transportation means can be designed as a passenger vehicle, van, truck, motorcycle, aircraft, and/or water vehicle. The method can also be designated as a method for handling a bus system or network or for troubleshooting in the communication between control devices. It can be carried out for example at a standstill (in repair shop operation or in the parked state) or also during travel (in customer operations/customer use). In a first step, a message is requested by a first control device from a second control device. The first control device thus has a need for communication or the intention of obtaining information from the second control device. The communication between the first control device and the second control device can take place with mediation of a bus system, network, or a proprietary line (for example twisted metallic conductors). In a next step, it is determined that the second control device does not react to the request. In other words, the first control device does not receive the requested message from the second control device, at least within a predefined time span. In response thereto, a data set assigned to the second control device is automatically adapted. In other words, the data set which can influence the behavior of the second control device is automatically adapted. For this purpose, an alternative data set can be created or an existing (previous) data set can be adapted. The adaptation can be initiated by the first control device. The adapted data set is then written on an instance located outside the second control device. This takes place automatically and still in response to the determination of the fact that the second control device has not reacted to the request. The instance located outside the second control device is also in the vehicle electrical system of the transportation means or connected in terms of information to an external computing unit (such as a backend server) connected in terms of information to the transportation means. In this way, the instance can experience a function change in that in a last step it applies the data set to initiate a reaction of the second control unit to the request. In other words, the instance is prompted by the change of the data set to operate the second control device with respect to information and/or energetically in a modified manner or to operate it energetically/with respect to information at all. Due to the automatic adaptation and the automatic writing of the data set, the transportation means is so to speak capable of automatically “repairing” the communication between the first control device and the second control device. In other words, the transportation means is made capable of remedying a communication error using the data set and the instance. As a result, it is possible to avoid a developer and/or an external laptop, or the like, having to be used in order to provide the instance with the adapted data set, so that the second control device can be incorporated into the communication with the first control device.

The instance can be, for example, a switching device like a relay or an eFuse and/or a semiconductor switch. In other words, the instance is capable of connecting or interrupting an (energy and/or communication) line between the second instance and the vehicle electrical system or parts thereof. Depending on the design, the instance can also be designed as a further control device or as a backend server. With respect to the complexity of the instance, a delimitation from other control devices is not necessarily required. This is already due to the fact that certain functions migrate among one another during the development of a transportation means. However, it is important in particular in the meaning of the present subject matter that the instance is connected via a line or a bus system or a network to the first control device and/or the second control device, on the one hand to bring about the function change by means of the data set and on the other hand to reestablish the communication/electrical supply of the second control device.

The data set can be embodied, for example, as a data supply table, as is used for coding control devices. In particular, the behavior of the second control device and/or the instance can be defined in the data supply table. This does not exclude the data set defining the behavior of further control devices and/or instances of the transportation means. The data set can thus relate, for example, to the behavior of different control devices within the same transportation means or even spanning transportation means. The data set can define, for example, how the instance behaves with respect to the second control device or which functions the instance permits with respect to the second control device. In particular, the instance can be prompted by the data set to link certain pins of the second control device to peripheral equipment or to disconnect this connection.

The request which the first control device directs to the second control device can relate, for example, to a sensor value and/or a bus message and/or network message and/or a status request. Depending on which functions and items of information the second control device provides, the need of the first control device for the functions/items of information can be based on a current vehicle situation/driving situation. Alternatively or additionally, for example, an error memory from the second control device can be read out or at least the attempt in this regard can be undertaken (for example in a repair shop). In this case, the feedback of possible error memory entries to the first control device by the message would be the subject matter of the request.

The reason that the second control device does not react (as desired) to the request can be that, for example, the second control device is currently not supplied with energy and/or is not linked to a communication channel. The communication channel can in particular be a software channel or a slot on a digital communication channel. In particular, a detached plug connection or the like cannot be remedied in software by the adapted data set and is thus not to be understood as a repair option according to the present subject matter. A further possibility for why the second control device does not react to the request can be a nonexistent incorporation into a communication network group (domain), so that the second control device is not authorized to receive the requested information or to send the obtained information to the first control device. Such an incorporation can also take place via the adapted functionality of the instance by means of the adapted data set.

Accordingly, the instance can cause energizing (energetic supply) of the second control device and/or an authorization of a data exchange of the second control device with the first control device by application of the adapted data set. No user interaction is thus necessary in order to reestablish the desired functionality of the second control device (in connection with the instance).

For example, the requesting and the writing of the message or the adapted data set can take place via a bus system or network. Nonexhaustive examples of corresponding bus systems or networks are CAN, CAN-XL, MOST, LIN, USB, PCIe, FLEX Ray, ethernet, etc. In principle, a wireless communication between the relevant hardware components first control device, instance, and second control device is also possible, wherein in particular a communication malfunction of the second control device can be remedied in this context since an electrical connection of the respective receiver is a fundamental requirement.

In principle, it is thus proposed that faulty (system) functions due to missing messages be repaired in the vehicle electrical system by an (in particular self-learning) algorithm. This can create self-clustering power supply states and/or communication subnetworks. In the case of a message which is not received, a “repair message” can be created, which is sent in particular by the first control device. The repair message contains the information about the missing or non-received message. For example, this message can be named on the basis of an identification (ID). On the basis of the ID, the first control device can determine the instance or the second control device and act by means of the adapted data set such that the second control device can again be properly addressed and used in future.

Exemplary scenarios according to the present subject matter are described hereinafter without restriction of the above statements and subjects:

The example of a communication subnetwork “climate control” is considered. The communication subnetwork master is located in the central control device. In this communication subnetwork climate control, the air-conditioners and the heating elements of the front row of seats are accommodated, but not the air-conditioners in the rear. The air-conditioners in the front row seats and in the rear are each energetically supplied. The function of climate control expects the confirmation of the arrival of specific climate control messages (acknowledgment messages) from the air-conditioners in the front row seats and from the air-conditioners in the rear. Due to the non-arrival of the air-conditioners in the rear in the communication part climate control, the function of climate control does not receive feedback from the air-conditioners in the rear. Prompted by this, the communication subnetwork master as the first control device sends a “repair message” to an instance within the vehicle electrical system of the transportation means. In response to the reception of the adapted data set, the instance adds the air-conditioners in the rear to the communication subnetwork climate control, which reestablishes the function and results in the avoidance of error memory entries.

The example “power supply cluster climate control” will be considered next. The power supply cluster master as the first control device is located in the central control device (for example the head unit). In this power supply cluster climate control, the air-conditioners of the front row seats are supplied with energy, but not the air-conditioners in the rear. The function “climate control” expects the confirmation of the arrival of specific climate control messages from the air-conditioners in the front row seats and in the rear. Due to the nonarrival of the air-conditioners in the rear in the communication subnetwork climate control, the function climate control does not receive feedback from the air-conditioners in the rear. The first control device thus drafts an adapted data set as a “repair message” and sends it to the instance, which can also be located, for example, in the central control device/first control device. The message can read, for example, “missing message of the air-conditioners in the rear”. As a result, the algorithm adds the air-conditioners in the rear to the power supply cluster climate control due to the use of the adapted data set, which results in a functioning function and the avoidance of error memory entries.

### BRIEF DESCRIPTION OF THE DRAWINGS

FIG. 1 shows a schematic representation of a transportation means designed according to the present subject matter having an exemplary embodiment of a controller group according to the present subject matter; and

FIG. 2 shows a flow chart illustrating steps of an exemplary embodiment of a method according to the present subject matter for communication between control devices of a transportation means.

### DETAILED DESCRIPTION OF THE DRAWINGS

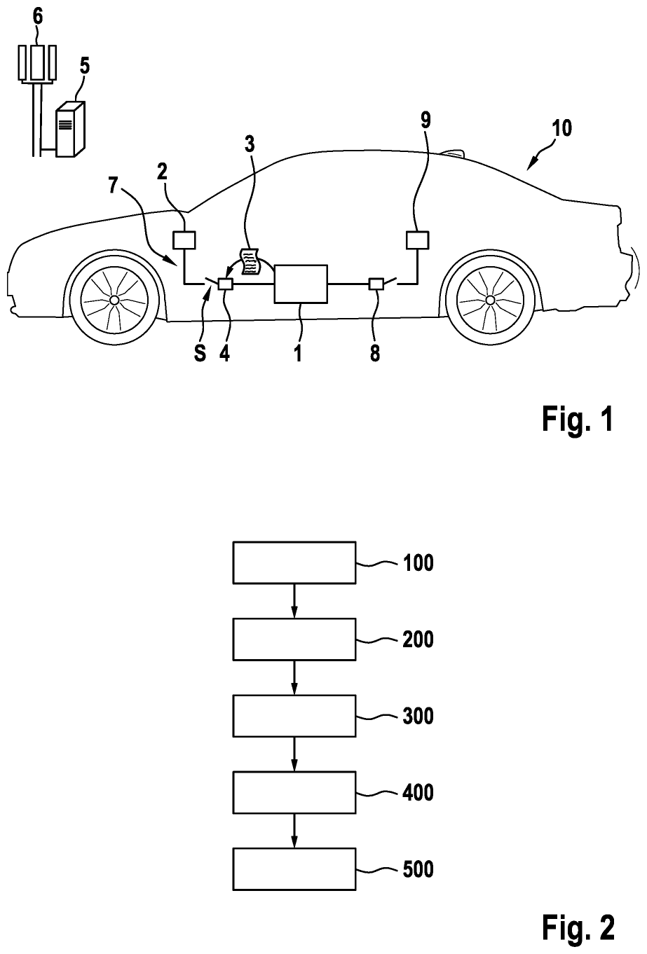

FIG. 1 shows a passenger vehicle as a transportation means 10, which has a controller group comprising a bus system 7. A first (central) control device 1 is linked here with respect to information to a first instance 4 and a second instance 8. Both establish an energy supply and a communication connection between the respective second control device 2 or 9 and the first control device 1. The first control device 1 now has a need for data possibly provided by the second control device 2. A corresponding request cannot be fulfilled by the second control device 2, since the second control device 2 is without power and without a communication channel to the first control device 1. Accordingly, a data set 3 automatically adapted within the transportation means (for example by the first control device or another control device) is sent to the first instance 4, in response to which it closes a switch S and thus reestablishes an energy supply and communication incorporation of the second control device 2. An alternative possibility for reestablishing the function is, as shown, the first control device 1 reporting the need and/or the error in communication to a backend server 5 linked via a radio tower 6, which in response thereto sends an adapted data set 3 to the first instance 4. By applying the changed data set 3, the instance 4 can close the switch S and reestablish the communication in the transportation means 10.

FIG. 2 shows steps of an exemplary embodiment of a method according to the present subject matter for communication between control devices for a transportation means or for reestablishing a communication between two control devices for a transportation means. In step 100, a message is requested by a first control device from a second control device. The need for communication or information can have arisen, for example, due to a current vehicle status, a user input, or a driving situation. In step 200, it is determined that the second control device does not react (as desired) to the request. This can mean that the control device does not send back a message or does not send back a message sent upon the request to the first control device. In step 300, in response thereto, a data set assigned to the second control device is modified or provided with new data, which can be carried out in particular by means of a self-learning algorithm. The data set may have been created in this case on the basis of a large number of error cases in the transportation means or may have been adapted by a self-learning algorithm and/or a neural network. In step 400, the data set is then written on an instance located outside the second control device in the vehicle electrical system of the transportation means. In this way, the instance is made capable of adapting the behavior of the second control device for the future. For example, the instance can comprise an eFuse or a relay or the like. Finally, in step 500, the data set which has previously been adapted, is used in the instance to initiate a reaction of the second control device to the request. In other words, the data set is consulted after the automatic writing by the instance in order to influence the functionality of the instance with respect to the second control device. For example, the instance can thereupon and in dependence on the adapted data set supply the second control device with electrical energy and/or reestablish a communication channel to the second control device.

The term module (and other similar terms such as unit, subunit, submodule, etc.) in the present disclosure may refer to a software module, a hardware module, or a combination thereof. Modules implemented by software are stored in memory or non-transitory computer-readable medium. The software modules, which include computer instructions or computer code, stored in the memory or medium can run on a processor or circuitry (e.g., ASIC, PLA, DSP, FPGA, or other integrated circuit) capable of executing computer instructions or computer code. A hardware module may be implemented using one or more processors or circuitry. A processor or circuitry can be used to implement one or more hardware modules. Each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices and stored in memory or non-transitory computer readable medium.

### LIST OF REFERENCE SIGNS

1 first control device
2 second control device
3 data set
4 first instance
5 backend server
6 radio tower
7 vehicle electrical system
8 second instance
9 further second control device
10 passenger vehicle
100 to 500 method steps
S switch

1.-10. (canceled)

11. A method for communication between electronic control devices for a transportation vehicle, comprising:
sending a request by a first electronic control device to a second electronic control device;
determining that the second electronic control device does not react to the request in response:
automatically adapting a data set assigned to the second electronic control device,
automatically writing the data set on an instance located outside the second electronic control device, and
applying the data set in the instance to initiate a reaction of the second electronic control device to the request.

12. The method according to claim 11, wherein the instance comprises:
a switching device,
a semiconductor switch,
an eFuse,
a further electronic control device, and/or
a backend server.

13. The method according to claim 11, wherein
the data set comprises a data supply table.

14. The method according to claim 11, wherein
the data set has data for defining a mode of operation of a plurality of electronic control devices and/or instances contained in an electrical system of the transportation vehicle.

15. The method according to claim 11, wherein
the request relates to a sensor value and/or a bus message and/or a network message and/or a status query.

16. The method according to claim 11, wherein
the second electronic control device does not react to the request since the second electronic control device is not:
supplied with energy,
linked to a communication channel,
contained in a communication network group, and/or
authorized to receive a requested item of information.

17. The method according to claim 11, wherein
the instance causes, in dependence on the use of the data set:
energizing of the second electronic control device, and/or
authorizing of data exchange of the second electronic control device with the first electronic control device.

18. The method according to claim 11, wherein
the request and the writing take place via a bus system or network of the transportation vehicle.

19. A controller group for a transportation vehicle, comprising:
a processor; and
a memory in communication with the processor and storing instructions executable by the processor to configure the controller group to:
send a request by a first electronic control device to a second electronic control device;
determine that the second electronic control device does not react to the request in response:
automatically adapt a data set assigned to the second electronic control device,
automatically write the data set on an instance located outside the second electronic control device, and
apply the data set in the instance to initiate a reaction of the second electronic control device to the request.

20. A transportation vehicle comprising the controller group according to claim 19.
